(19) United States
(12) Patent Application Publication
(10) Pub. No.: US 2007/0041600 A1
(43) Pub. Date: Feb. 22, 2007

(54) ELECTRO-MECHANICAL SYSTEMS FOR ENABLING THE HEARING IMPAIRED AND THE VISUALLY IMPAIRED

(76) Inventor: James M. Zachman, Dallas, TX (US)

Correspondence Address: MICHAEL A. O'NEIL, P.C., 5949 SHERRY LANE, SUITE 820, DALLAS, TX, 75225, US

(21) Appl. No.: 11/382,629

(22) Filed: May 10, 2006

Related U.S. Application Data
(60) Provisional application No. 60/710,279, filed on Aug. 22, 2005.
(60) Provisional application No. 60/757,332, filed on Jan. 9, 2006.

(51) Int. Cl. H04R 25/00

(52) U.S. Cl. 381/312; 381/316

(57) ABSTRACT

A system for enabling the hearing impaired comprises a plurality of servo actuators each associated with a particular segment of a predetermined frequency domain. The servo actuators drive tactile stimulators which engage the skin of the hearing impaired person in patterns that are unique to individual inputs thereby enabling the hearing impaired person to “hear” signals within the defined frequency domain. An electromechanical system for enabling the visually impaired comprises a two dimension array of servo actuators which respond to optical sensors and which actuate tactile stimulators thereby identifying objects in the path of the visually impaired person.

### CLAIM OF PRIORITY

Applicant claims priority based on provisional patent application Ser. No. 60/710,279 filed Aug. 22, 2005, the entire content of which is incorporated herein by reference; and provisional patent application Ser. No. 60/757,332 filed Jan. 9, 2006, the entire content of which is incorporated herein by reference.

### TECHNICAL FIELD

This invention relates to systems for allowing the hearing impaired to “hear” and for allowing the visually impaired to “see”, and more particularly to electromechanical systems which provide tactile stimuli in lieu of or in addition to conventional hearing and sight.

### BACKGROUND AND SUMMARY OF THE INVENTION

Hearing aids, particularly the modern digital varieties, are highly useful to persons with limited to moderate hearing loss but provide no assistance to persons that are either totally deaf or very nearly so. Similarly, eye glasses and contact lenses are highly useful to persons with limited to moderate visual impairment but provide no relief to persons that are totally blind or nearly so.

The present invention comprises electromechanical systems that allow the hearing impaired, i.e., deaf and nearly deaf persons to “hear”. More specifically, systems incorporating the invention convert sound waves into unique tactical stimuli. Once trained, a deaf or nearly deaf person associates particularly sets of stimuli with particular sounds comprising both conventional speech and other sounds including “sounds” at frequencies that are both above and below the normal range of human hearing. The system also allows deaf and nearly deaf persons to “hear”, and thereby correct, their own speech patterns.

Similarly, systems incorporating the present invention utilize optical sensors to recognize the presence of objects such as doors, furniture, etc. which comprise impediments to the movement of the visually impaired, i.e., blind and nearly blind persons. Signals from the optical sensors are converted into tactile stimuli which alert a blind or nearly blind person to not only the presence of but also the size and shape of an object positioned in his or her path. In this manner systems incorporating the invention allow blind and nearly blind persons to either avoid impediments to their travel or to locate objects that they need to use such as chairs, tables, doors, etc.

In accordance with more specific aspects of the invention, a system for aiding hearing impaired persons includes a microphone connected to a signal processing system which is in turn connected to an array of servo actuators positioned for tactile contact with the skin of the hearing impaired person. The signal processing system analyzes incoming signals in real time and extracts frequency domain information therefrom. The frequency domain information is in turn used to drive the array of servo actuators, with each servo actuator being responsive to the magnitude of the frequency domain energy comprising a particular segment of the frequency domain.

In accordance with another aspect of the invention, a photosensor is connected to a signal processing system which is in turn connected to an array of servo actuators that are placed in contact with the skin of a visually impaired person. The signal processing system analyzes the signal received from the photo processor in real time and drives the array of servo actuators. The servo actuators provide tactile stimulation which alerts the visually impaired person not only as to the presence of an object in his/her path, but also as to the size and shape of the object.

### BRIEF DESCRIPTION OF THE DRAWINGS

A more complete understanding of the present invention may be had by reference to the following Detailed Description when taken in connection with the accompanying Drawings, wherein:

FIG. 1 is a diagrammatic illustration of the use of a first embodiment of the invention;

FIG. 2 is a perspective view of the first embodiment of the invention;

FIG. 3 is a circuit diagram illustrating the operation of the first embodiment of the invention; and

FIG. 4 is a diagrammatic illustration of a second embodiment of the invention.

### DETAILED DESCRIPTION

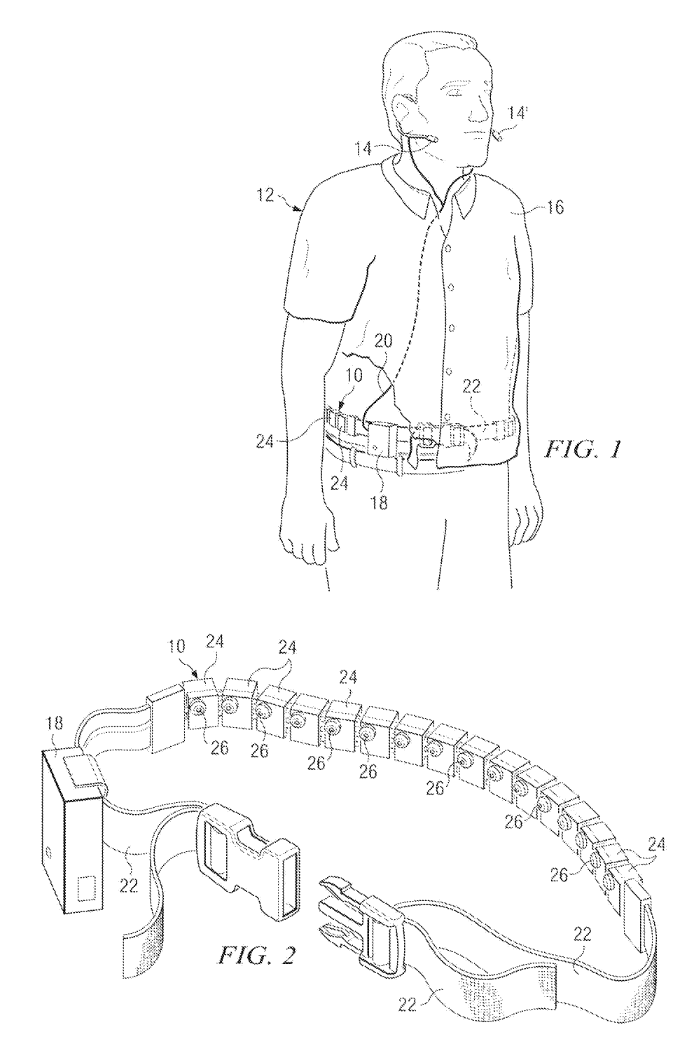

Referring to FIGS. 1, 2, and 3, there is shown an electromechanical system for aiding the hearing impaired 10 comprising a first embodiment of the invention. As used herein, the phrase “hearing impaired person” means a person that is either deaf or nearly so.

Referring particularly to FIG. 1, a hearing impaired person 12 is provided with at least one microphone 14 which is preferably positioned as closely as possible to an ear of the person 12 in the manner shown in FIG. 1. Alternatively, the microphone 14 can be mounted on a shirt 16 or other garment extending across the upper body of the person 12.

Regardless of where it is located, the microphone 14 is electrically connected to electric circuitry mounted within a box 18 by a cable 20. The box 18 is supported on a belt 22 extending around the waist of the person 12 and contains both the power supply for and the operating circuitry of the system 10.

Referring to FIG. 2, the belt 22 also supports a plurality of servo actuators 24 each identified with and responsive to a particular segment of the frequency domain comprising audible sound, including human speech. In certain applications of the invention the frequency domain comprising audible sound is divided into a predetermined number of equal segments each corresponding to one of the servo actuators 24. In other applications of the invention certain of the servo actuators 24 may correspond to larger segments of the frequency domain comprising audible sound while the remainder of the servo actuators 24 correspond to smaller segments thereof.

Each of the servo actuators 24 is provided with a tactile stimulator 26. The tactile stimulator 26 comprising each servo actuators 24 is responsive to the magnitude of the frequency domain energy comprising a particular segment of the frequency domain comprising audible sound. Thus, if the magnitude of the frequency domain energy comprising a particular segment of the audible sound frequency domain is large, the tactile actuator 26 is extended further and with more pressure relative to the tactile stimulator 26 of a servo actuator 24 associated with a segment of the frequency domain comprising audible sound having a lower frequency domain energy.

Referring again to FIG. 2, the tactile stimulators 26 of the servo actuators 24 are preferably positioned in direct contact with the skin of the person 12. Alternatively, a thin, highly flexible cloth layer may be positioned between the tactile stimulators 26 and the skin of the person 12. In this manner the stimulation provided by the tactile actuators 26 to the skin of the person 12 is more readily discernable than would otherwise be the case.

As is also shown in FIG. 1, the system 10 comprising the present invention may be provided with a second microphone 14′. The use of the second microphone 14′ is advantageous in that it allows the hearing impaired person 12 to better determine the location of the source of audible sound which is activating the system 10. The second microphone 14′ may be used to actuate a second belt 22 located either immediately above or immediately below the belt 22 shown in FIG. 1. Alternatively, the second microphone 14′ may be utilized to operate the servo actuators 24 in the opposite direction as compared with the operation thereof responsive to the microphone 14.

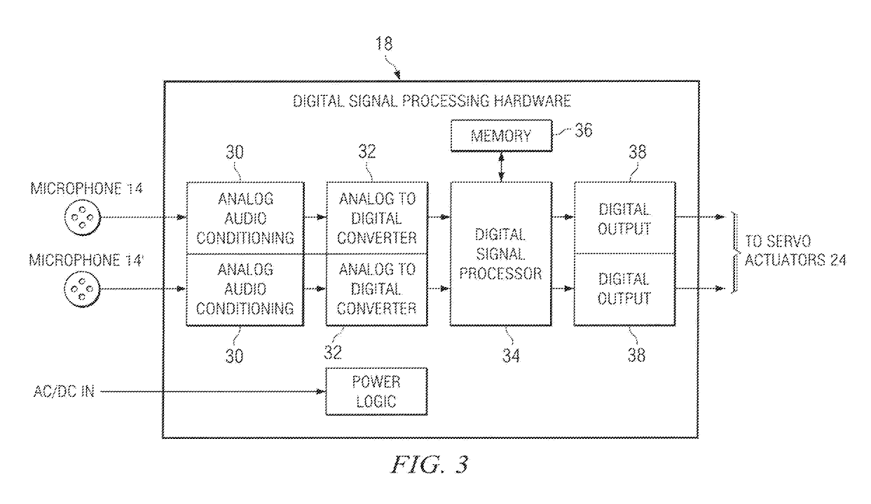

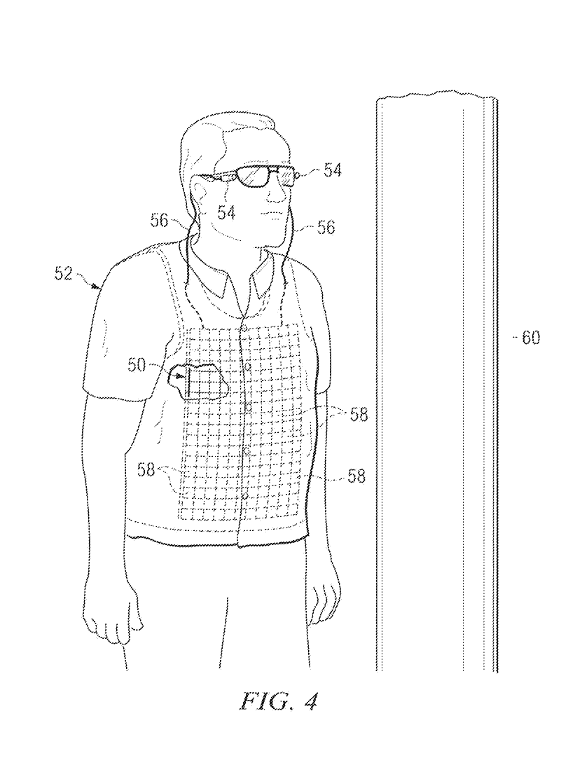

Referring to FIG. 3, the electronic components comprising the system 10 are diagrammatically illustrated. Signals received from one or both of the microphones 14 and 14′ are directed through analog audio conditioning circuits 30 and analog to digital converter circuits 32 and are received by a digital signal processor circuitry 34. The digital signal processor circuitry 34 is coupled to a memory 36 and functions to actuate digital output circuits 38 which are operatively connected to the servo actuators 24. In this manner the tactile stimulators 26 are actuated to provide tactile stimuli to the person 12 equipped with the system 10 which is indicative of the magnitude of the frequency domain energy comprising the particular segment of the audible sound frequency domain associated with a particular servo actuator 24.

Utilization of the system 10 comprising the first embodiment of the invention requires training of the hearing impaired person 12. In one example training begins with a display of a common word to the hearing impaired person 12, for example, the word “LOOK”. Simultaneously the displayed word is spoken by a person having excellent diction. For example, the speaker might be an actor, a diction coach, a radio or television personality, etc.

The sound pattern comprising the spoken word is received either by the microphone 14 or by the microphones 14 and 14′. The signals generated by the microphone 14 or by the microphones 14 and 14′ are directed to the circuitry illustrated in FIG. 3 and described hereinabove in conjunction therewith. The circuitry comprising FIG. 3 functions in real time to actuate the tactile stimulators 26 of the servo actuators 24 to provide a unique set of tactile stimuli which is associated with the word that was displayed and spoken. Over time the hearing impaired person 12 learns to recognize the patterns of stimuli associated with particular words to the point that the hearing impaired person 12 can fully and completely receive and process audible sound, including human speech not withstanding the fact that the person 12 is either deaf or nearly so.

Another aspect of the invention comprises the training of the hearing impaired person 12 to properly speak a particular language. In such cases a displayed word is spoken by the hearing impaired person 12. The word spoken by the hearing impaired person 12 is received by the microphone 14 or by the microphone 14 and the microphone 14′ and is directed through the circuitry comprising FIG. 3 whereby the tactile stimulators 26 of the servo actuators 24 are actuated. The hearing impaired person 12 compares the stimulation received from the tactile actuators 26 when he or she has spoken a particular word with a previous experience wherein the same word was spoken by a person having a professional speaking voice. In this manner the speaking voice of the hearing impaired person 12 is trained to match the diction of the professionally trained speaker.

As will be apparent from the foregoing, the present invention is particularly adapted at allowing hearing impaired individuals to “hear” audible sound in the frequency range which includes human speech. As will be appreciated by those skilled in the art, the system of the present invention is further adapted to allow both hearing impaired and non-hearing impaired individuals to respond to “sounds” that are above and below the normal range of human hearing. Of equal importance is the fact that although the system has been illustrated as comprising a plurality of tactile stimulators supported on a belt for engagement with the waist of an individual, the tactile stimulators of the present invention can be positioned for engagement with skin comprising any portion of the human body and supported thereon by devices other than belts.

Referring to FIG. 4, there is shown an electromechanical system for aiding the visually impaired 50 comprising a second embodiment of the invention. As used herein, the phrase “visually impaired person” means a person that is either blind or nearly so.

A visually impaired person 52 is provided with a pair of optical sensors, i.e., cameras 54 which are located as closely as possible to the eyes of the visually impaired person 52 in the manner illustrated in FIG. 4. The optical sensors 54 are connected through leads 56 to electronic circuitry that is similar in construction and function to the circuitry illustrated in FIG. 3 and described hereinabove in conjunction therewith. The electronic circuitry produces outputs which actuate a plurality of servo actuators 58 which are substantially identical in construction and function to the servo actuators 24 of the system 10 as illustrated in FIG. 4 and described hereinabove in conjunction therewith.

The servo actuators 58 of the system 50 are arranged in a two dimensional array. This allows the tactile stimulators of the servo actuators 58 to form an “image” of an object 60 situated in the path of the visually impaired person 52 on the skin of the visually person. The object 60 may comprise an impediment to the travel of the visually impaired person 52. Alternatively, the object 60 may comprise an article useful to the visually impaired person 52 such as a chair, table, etc.

By means of the present invention the visually impaired person 52 is able to move about much more freely than would otherwise be the case. The system 50 is to alert the visually impaired person 52 to the presence of objects in his or her path and to the fullest possible extent to make the visually impaired person 52 aware of the object in his or her path. In this manner the visually impaired person can not only identify obstructions but can also identify desired objects such as chairs, tables, and the like.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method of aiding hearing impaired persons in sound recognition comprising the steps of:
defining a frequency domain comprising audible sound, including human speech;
segregating the defined frequency domain into a predetermined number of discrete frequency segments;
providing a plurality of servo actuators equal in number to the predetermined number of discrete frequency segments;
associating each of the servo actuators with one of the discrete frequency segments;
positioning each of the servo actuators for tactile stimulation of a predetermined region of the skin of a hearing impaired person;
receiving signals within the defined frequency domain;
determining the energy levels of the portions of the received signals comprising each of the discrete frequency segments thereof; and
causing each of the servo actuators to produce a tactile stimulation of the predetermined region of the skin of the hearing impaired person corresponding to the determined energy level of the discrete frequency segment associated therewith.

2. The method of aiding hearing impaired persons in sound recognition according to claim 1 wherein the step of providing a plurality of servo actuators is further characterized by providing a plurality of servo actuators each having a servo actuated push rod and wherein the step of positioning each of the servo actuators for tactile stimulation of a predetermined region of the skin of a hearing impaired person is further characterized by positioning each of the servo actuators for tactile stimulation of a predetermined region of the skin of a hearing impaired person by actuation of the push rod thereof.

3. The method of aiding hearing impaired persons in sound recognition according to claim 2 wherein the step of positioning each of the servo actuators for tactile stimulation of a predetermined region of the skin of a hearing impaired person is further characterized by positioning each of the servo actuators for direct engagement with the skin of a hearing impaired person by the push rod of the servo actuator.

4. The method of aiding hearing impaired persons in sound recognition according to claim 2 wherein the step of positioning each of the servo actuators for tactile stimulation of a predetermined region of the skin of a hearing impaired person is further characterized by positioning each of the servo actuators for tactile engagement with the skin of a hearing impaired person by engagement of the push rod of the servo actuator with a clothing layer extending across the predetermined region of the skin of the hearing impaired person.

5. The method of aiding hearing impaired persons in sound recognition according to claim 1 wherein the step of providing a plurality of servo actuators is further characterized by providing a plurality of servo actuators each having a push rod;
wherein the step of positioning each of the servo actuators for tactile stimulation of a predetermined region of the skin of a hearing impaired person is further characterized by mounting all of the servo actuators on supporting means;
and including the additional step of securing the supporting means around a predetermined region of the body of a hearing impaired person and thereby positioning the push rods of the servo actuators for tactile stimulation of a predetermined region of the skin of a hearing impaired person.

6. The method of aiding hearing impaired persons in sound recognition according to claim 5 wherein the step of positioning each of the servo actuators for tactile stimulation of a predetermined region of the skin of a hearing impaired person is further characterized by positioning each of the servo actuators for direct engagement with the skin of a hearing impaired person by the push rod of the servo actuator.

7. The method of aiding hearing impaired persons in sound recognition according to claim 5 wherein the step of positioning each of the servo actuators for tactile stimulation of a predetermined region of the skin of a hearing impaired person is further characterized by positioning each of the servo actuators for tactile engagement with the skin of a hearing impaired person by engagement of the push rod of the servo actuator with a clothing layer extending across the predetermined region of the skin of the hearing impaired person.

8. The method of aiding hearing impaired persons in sound recognition according to claim 1 including the additional step of providing a microphone for receiving audible sound, including human speech and for generating electrical signals analogous to the received audible sound, and wherein each of the servo actuators is responsive to signals received from the microphone for producing tactile stimulation of the predetermined region of the skin of a hearing impaired person.

9. The method of aiding hearing impaired persons in sound recognition according to claim 8 further characterized by:
providing a second microphone for receiving audible sound and for generating electrical signals corresponding thereto;
providing a second plurality of servo actuators equal in number to the predetermined number of discrete frequency segments; and
causing each of the second plurality of servo actuators to produce tactile stimulation of a second predetermined region of the skin of the hearing impaired person in response to signals received from the second microphone;
thereby enabling the hearing impaired person to determine the location of the source of the audible sound received by the first and second microphones.

10. The method of aiding hearing impaired persons in sound recognition according to claim 1 wherein:
the step of providing a plurality of servo actuators is further characterized by providing a plurality of servo actuators each having a servo actuated push rod;
wherein the step of positioning the servo actuators for tactile stimulation of a predetermined region of the skin of a hearing impaired person is further characterized by positioning each of the servo actuators for tactile stimulation of a predetermined region of the skin of a hearing impaired person by actuation of the push rod thereof;
and including the additional step of providing a microphone for receiving audible sound, including human speech and for generating electrical signals analogous to the received audible sound; and
each of the servo actuators being responsive to signals received from the microphone for actuating the push rod thereof to produce tactile stimulation of the predetermined region of the skin of the hearing impaired person.

11. The method of aiding visually impaired persons in recognizing objects in their path of travel comprising the steps of:
providing a photosensor;
utilizing the photosensor to generate an image of the path of travel of a visually impaired person;
segregating the image of the path of travel of the visually impaired person into a predetermined number of discrete regions;
providing a plurality of servo actuators equal in number to the predetermined number of discrete regions;
associating each of the servo actuators with one of the discrete regions;
positioning each of the servo actuators for tactile stimulation of a predetermined region of the skin of the visually impaired person;
determining the intensity of the light comprising each segment of the image of the path of travel of the visually impaired person; and
causing each of the photo actuators to produce a tactile stimulation on the predetermined region of the skin of the visually impaired person corresponding to the intensity of the light comprising the segment of the image of the path of travel of the visually impaired person associated therewith.

12. The method of aiding visually impaired persons according to claim 11 wherein the step of providing a plurality of servo actuators is further characterized by providing a plurality of servo actuators each having a servo actuated push rod and wherein the step of positioning each of the servo actuators for tactile stimulation of a predetermined region of the skin of a visually impaired person is further characterized by positioning each of the servo actuators for tactile stimulation of a predetermined region of the skin of a visually impaired person by actuation of the push rod thereof.

13. The method of aiding visually impaired persons according to claim 12 wherein the step of positioning each of the servo actuators for tactile stimulation of a predetermined region of the skin of a visually impaired person is further characterized by positioning each of the servo actuators for direct engagement with the skin of a visually impaired person by the push rod of the servo actuator.

14. The method of aiding visually impaired persons according to claim 12 wherein the step of positioning each of the servo actuators for tactile stimulation of a predetermined region of the skin of a visually impaired person is further characterized by positioning each of the servo actuators for tactile engagement with the skin of a visually impaired person by engagement of the push rod of the servo actuator with a clothing layer extending across the predetermined region of the skin of the visually impaired person.

15. The method of aiding visually impaired persons according to claim 11 wherein the step of providing a plurality of servo actuators is further characterized by providing a plurality of servo actuators each having a push rod;
wherein the step of positioning each of the servo actuators for tactile stimulation of a predetermined region of the skin of a visually impaired person is further characterized by mounting all of the servo actuators on a garment;
and including the additional step of securing the garment around a predetermined region of the body of a visually impaired person and thereby positioning the push rods of the servo actuators for tactile stimulation of a predetermined region of the skin of a visually impaired person.

16. The method of aiding visually impaired persons according to claim 15 wherein the step of positioning each of the servo actuators for tactile stimulation of a predetermined region of the skin of a visually impaired person is further characterized by positioning each of the servo actuators for direct engagement with the skin of a visually impaired person by the push rod of the servo actuator.

17. The method of aiding visually impaired persons according to claim 15 wherein the step of positioning each of the servo actuators for tactile stimulation of a predetermined region of the skin of a visually impaired person is further characterized by positioning each of the servo actuators for tactile engagement with the skin of a visually impaired person by engagement of the push rod of the servo actuator with a clothing layer extending across the predetermined region of the skin of the visually impaired person.

18. The method of aiding visually impaired persons according to claim 11 including the additional step of providing a camera for generating electrical signals analogous to the path of travel of a visually impaired person, and wherein each of the servo actuators is responsive to signals received from the camera for producing tactile stimulation of the predetermined region of the skin of a visually impaired person.

19. The method of aiding visually impaired persons according to claim 8 further characterized by:
providing a second camera for generating electrical signals corresponding to the path of travel of a visually impaired person;
providing a second plurality of servo actuators equal in number to the predetermined number of discrete regions; and
causing each of the second plurality of servo actuators to produce tactile stimulation of a second predetermined region of the skin of the visually impaired person in response to signals received from the second camera;
thereby enabling the visually impaired person to determine the location of objects in his/her path of travel.

20. The method of aiding visually impaired persons in sound recognition according to claim 1 wherein:
the step of providing a plurality of servo actuators is further characterized by providing a plurality of servo actuators each having a servo actuated push rod;
wherein the step of positioning the servo actuators for tactile stimulation of a predetermined region of the skin of a visually impaired person is further characterized by positioning each of the servo actuators for tactile stimulation of a predetermined region of the skin of a visually impaired person by actuation of the push rod thereof;
and including the additional step of providing a camera for generating electrical signals analogous to the path of travel of the visually impaired person;
each of the servo actuators being responsive to signals received from the camera for actuating the push rod thereof to produce tactile stimulation of the predetermined region of the skin of the visually impaired person.
